(19) United States
(12) Patent Application Publication
(10) Pub. No.: US 2010/0131757 A1
(43) Pub. Date: May 27, 2010

(54) DIGITAL INFORMATION SERVICE

(75) Inventors: Martin Orrell, Bedfordshire (GB); Tristan James Barkley, Suffolk (GB)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: THE TECHNOLOGY PARTNERSHIP PLC, Hertfordshire (GB)

(21) Appl. No.: 12/597,636

(22) PCT Filed: Apr. 25, 2008
(86) PCT No.: PCT/EP08/55122

§ 371 Date: Nov. 13, 2009

(30) Foreign Application Priority Data
Apr. 27, 2007 (GB) 0708218.3

(51) Int. Cl. H04L 29/06; G06F 21/00

(52) U.S. Cl. 713/162

(57) ABSTRACT

A system comprising a server which is arranged to store encrypted addresses and encryption information associated with the addresses. The server sending the addresses and encryption information to user equipment which is able to decrypt the encrypted addresses using the encryption information; and is able to access a locations associated with the addresses.

### FIELD OF THE INVENTION

The present invention relates to a method and a system, and in particular but not exclusively to a method and system for enabling a user to publish and/or discover multimedia content.

### BACKGROUND OF THE INVENTION

The internet has become an excellent vehicle for the distribution of content such as information, multimedia or interactive services. This content may be user generated as well as commercially generated. The content may be free to use or may be premium or protected content, requiring payment, subscription or registration to access.

A Personal Computer (PC) is often used as the main interface device between a user and this content. A PC enables a user to generate, publish, store, consume and interact with content. Searching tools exist (such as web based search engine) to aid the user in the discovery of new content.

This content can, for example, be multimedia such as pictures, music, podcasts and video streaming. Alternatively the content might be an interactive service. The content may be offered on the internet (such as on a server) or by any device to which user equipment may connect. This content may be protected by various systems such as Digital Rights Management (DRM) systems.

User equipment has been produced that allow users to create, store, consume and/or interact with such content. This content may be the users own content or may have been created by a third party. The content may be free to use or protected. Examples of such devices are mobile phones and MP3 players. However, these devices normally use a PC as their interface to discover and access the content. Consequently discovery of new content for these devices is not straightforward and relies on the user having a PC. Often the user equipment does not have its own method of content discovery.

Some portable devices are able to use search tools such as web based search engines. The problem with this is that searching is often difficult. It can be slow. Furthermore, since the screens of such user equipment are often small compared to a PC the presentation of information and the navigation to wanted content is often restricted, Wireless Application Protocol (WAP) on mobile phones is a good example of this limitation, In addition costs, such as that of data traffic, have also discouraged use of search engines on portable devices.

A problem with search engines is that they require the user to proactively seek content. Furthermore, a search engine is not able to present a simple listing of desired content to a user, the user is required to follow links from the search engine and access separate web pages to get to the content. This adds to the time, cost and difficulty of searching.

Internet stores exist that user equipment can connect to in order to obtain content. The problem is that these stores have difficulty in converting a PC User Interface (UI) to a non-PC UI. This non-PC UI might have a much smaller screen/display and limited user input and navigation features. These stores still require the user to search for information and may still require multiple pages and/or multiple stores to be accessed for information. Furthermore these stores must maintain a copy of the information.

There are companies that collect content for delivery as a service to users.

Different search engines and internet stores have a different ‘look and feel’. These search engines and internet stores may require a user to download and install specific software, such as a “plug-in”. A user would have to learn to use the different systems. This further adds to the time, cost and difficulty of searching.

### SUMMARY OF THE INVENTION

It is an aim of one or more embodiments of the invention to address or at least mitigate one or more of the problems ‘discussed above.

According to a first aspect of the invention there is provided a system comprising: a server arranged to store at least one encrypted address and encryption information associated with said at least one encrypted address; at least one user equipment comprising: means for receiving one or more of said at least one encrypted address and said encryption information; means for decrypting at least one of said one or more received encrypted addresses using said encryption information; and means for accessing a location associated with one of said at least one decrypted address.

Preferably said at least one user equipment comprises address storing means for storing said at least one decrypted address.

Preferably said at least one user equipment comprises means for selecting one of said at least one decrypted address, said means for accessing a location accessing a location associated with said selected address.

According to embodiments of the invention the system comprises at least one entity for providing one or more addresses to said server.

Preferably said at least one entity comprises means for encrypting said one or more addresses.

Preferably said at least one entity comprises: means for generating content; means for providing said content to a content store, wherein at least one of said one or more addresses is associated with the location of said content in said content store.

Said at least one entity may comprise said content store. Alternatively or additionally the system comprises a second entity, said second entity comprising said content store.

One or more or said at least one entities may comprise user equipment.

Alternatively or additionally one or more of said at least one entities may comprise a server.

Preferably said address is associated with description information. Said description information may comprise one or more of: a title; description; an identity of a third party associated with said address; file category; content category; genre; file type; file size; if the content is free to use; if the content requires subscription or payment; location information; user group information; links to a payment system; type of content protection system; links to a protection server; links to interaction servers; alternate sources of content.

Preferably said server comprises means for filtering, managing and/or categorizing said at least one encrypted address in dependence on said description information.

Preferably said at least one user equipment comprises means for filtering, managing and/or categorizing said at least one decrypted address in dependence on said description information.

Preferably said means for selecting is configured to select based upon said description information.

Preferably said means for accessing a location automatically accesses a location based upon said description information.

Preferably user equipment preferences are defined by said user equipment. Said user equipment preferences may comprise at least one of: a storage capability of the user equipment; an ability of the user equipment to access the content associated with an address; a user preference a location of the user equipment; a user specified location.

Preferably said server comprises means for filtering, managing and/or categorizing said at least one encrypted address in accordance with said user equipment preferences.

Preferably said at least one user equipment comprises means for filtering, managing and/or categorizing said at least one decrypted address in accordance with said user equipment preferences.

Preferably said means for selecting is configured to select based upon said user equipment preferences.

Preferably said means for accessing a location automatically accesses a location based upon said user equipment preferences.

Preferably said server further comprises means for providing validity information indicating that one or more of said at least one encrypted address is invalid.

Preferably said user equipment comprises means for updating said address storing means in dependence on said validity information.

According to embodiments of the invention said server comprises: means for storing user access information; means for receiving identity information from one or more of said at least one user equipment; means for selectively providing one or more of said at least one encrypted address to said one or more of said at least one user equipment in dependence on said user access information and said identity information.

Preferably said at least one encrypted address is associated with information which is interactive. Alternatively or additionally said at least one encrypted address may be associated with information which is user generated, free and/or rights managed.

According to embodiments of the invention, said at least one encrypted address is associated with content access authorization data. Said encrypted address may comprise said content access authorization data. Alternatively or additionally said description information comprises said content access authorization data.

Preferably said at least one entity comprises mans for generating said content access authorization data.

According to a second aspect of the invention there is provided a system comprising: a server comprising: means for storing one or more addresses; means for providing information indicating one or more addresses are not valid; at least one user equipment comprising: means for storing one or more of said addresses; means for receiving said information from said server; and means for updating said storing means in dependence on said information.

According to a third aspect of the invention there is provided a system comprising:

a server comprising means for storing one or more addresses;

at least one user equipment comprising: means for receiving said one or more addresses from said server; and means for filtering said one or more addresses in dependence on a parameter of said user equipment.

Preferably said parameter of said user equipment comprises at least one of: a storage capability of the user equipment; an ability of the user equipment to access the content associated with an address; a user preference; a location of the user equipment; a user specified location.

According to a fourth aspect of the invention there is provided a server comprising: means for storing at least one address and user access information; means for receiving identity information from at least one user equipment; and means for selectively providing one or more of said at least one address to said at least one user equipment in dependence on said user access information and said identity information.

According to a fifth aspect of the invention there is provided a method comprising: storing on a server at least one encrypted address and encryption information associated with said at least one encrypted address; at least one user equipment comprising: receiving at user equipment one or more of said at least one encrypted address and said encryption information; decrypting at least one of said one or more received encrypted addresses using said encryption information; and accessing a location associated with one of said at least one decrypted address.

According to a sixth aspect of the invention there is provided a method comprising: storing on a server at least one encrypted address and encryption information associated with said at least one encrypted address; at least one user equipment comprising: transmitting to at least one user equipment one or more of said at least one encrypted address and said encryption information.

According to a seventh aspect of the invention there is provided a server comprising: means to store at least one encrypted address and encryption information associated with said at least one encrypted address; means to provide one or more of said at least one encrypted address and said encryption information to at least one user equipment.

Preferably said server comprises: means to receive one or more encrypted addresses.

According to a eighth aspect of the invention there is provided user equipment comprising: means for receiving one or more encrypted addresses and encryption information associated with said one or more encrypted addresses; means for decrypting at least one of said one or more received encrypted addresses using said encryption information; and means for accessing a location associated with one of said at least one decrypted address.

According to a ninth aspect of the invention there is provided an entity comprising: means for encrypting said one or more addresses associated with content; means for providing one or more or said encrypted addresses and encryption information associated with said encrypted addresses to a server;

Preferably said entity comprises: means for generating content; means for providing said content to a content store, wherein at least one of said one or more addresses is associated with the location of said content in said content store.

### BRIEF DESCRIPTION OF THE FIGURES

For a better understanding of the present invention, reference will now be made by way of example only to the accompanying drawings in which:

FIG. 1 shows a communications system in which embodiments of the present invention can be provided;

FIG. 2 shows a method embodying the invention for providing addresses of content to a server; and

FIG. 3 shows a method embodying the invention for receiving addresses of content from a server.

### DETAILED DESCRIPTION OF PREFERRED EMBODIMENTS OF THE INVENTION

An embodiment of the invention will now be described with reference to a communications system.

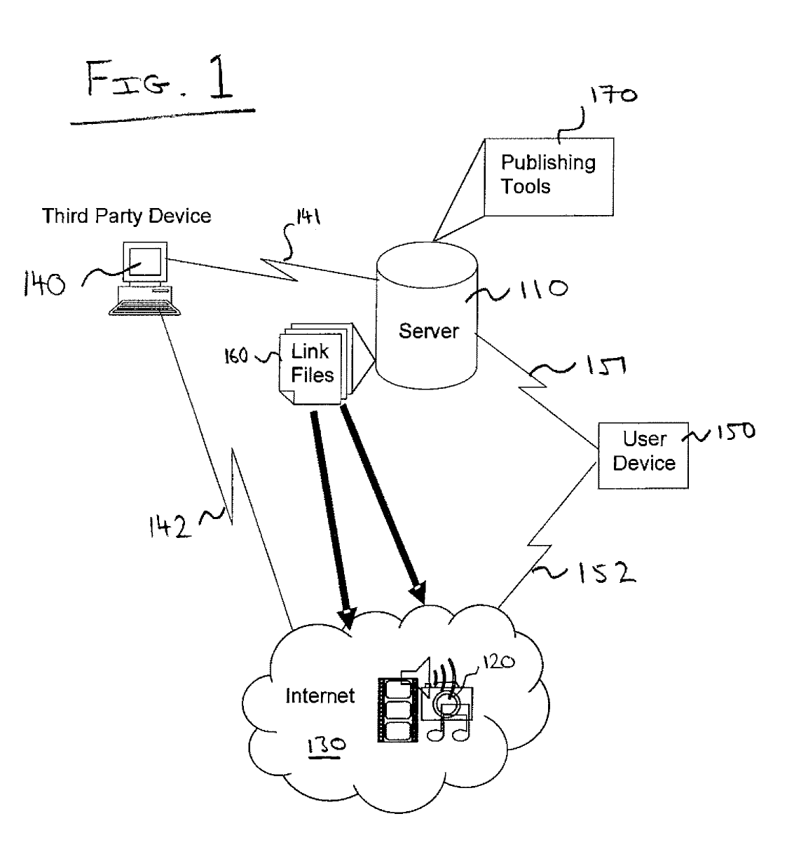

FIG. 1 illustrates the components of this communications system. A server 110 is provided, this server is able to store link files 160. These link files contain one or more addresses of content 120 which might be stored in the internet 130. The link files and/or addresses may be encrypted. The server may additionally store public encryption certificates associated with these encrypted link files and/or encrypted addresses. As will be described in more detail later, these certificates may be used to decrypt any encrypted link files and/or encrypted addresses.

A third party device 140 is able to determine the address of particular content. Accordingly the third party device may have a connection 142 to the internet where the content is stored. The third party device may upload this particular content to the internet. Alternatively or additionally the content may be from a different source, the third party device only determining the address. The third party device creates one or more link files containing one or more addresses of this content. The third party device may encrypt these link files and/or the addresses. The third party device has a connection 141 with the server and is able to upload these link files. The third party device may additionally upload public encryption certificates if the link files and/or addresses are encrypted. A third party is therefore able to publish link files on the server 110 which point a user to the address where content is stored on the internet.

The addresses stored in the link files may be Internet Protocol (IP) addresses. Alternatively they may be any similar address which is able to identify a device storing content. If the content is stored on a mobile telephone, the address might be an International Mobile Subscriber Identity (IMSI) or International Mobile Equipment Identity (IMEI) associated with that phone.

The server may store publishing tools 170 which may be used by the third party device to create (encrypt) and upload link files. These may be transmitted to the third party device or may be offered from the server (for example in a web page).

User equipment 150 has a connection 151 with the server through which it may receive the link files and public encryption certificates. The user equipment may decrypt the link files and/or addresses. The user equipment may store the link files and/or the addresses contained within the link files. The user equipment may have a connection 152 to the internet. Alternatively or additionally, the user equipment may have a connection to any device to which the user equipment may connect. The user equipment may be used to navigate the stored link files and/or addresses. The addresses of content may be used to access the content on the internet.

The connections between the server, the internet, the third party device and the user equipment may be via a wireless connection (WiFi), General Packet Radio Service (GPRS), Wideband Code Division Multiple Access (WCDMA), Third Generation (3G), Ethernet, fibre-optic cable or any other method known in the art. Different connections may be via different methods of connection. Moreover the connections to the server from the third party device and/or the user equipment may be through the internet, or via a particular network such as a mobile telecommunications network. Alternatively or additionally, telephone, fax and/or mail can be used for at least part of a connection, for example the publishing tools may be sent to the third party device via mail on a CD-ROM.

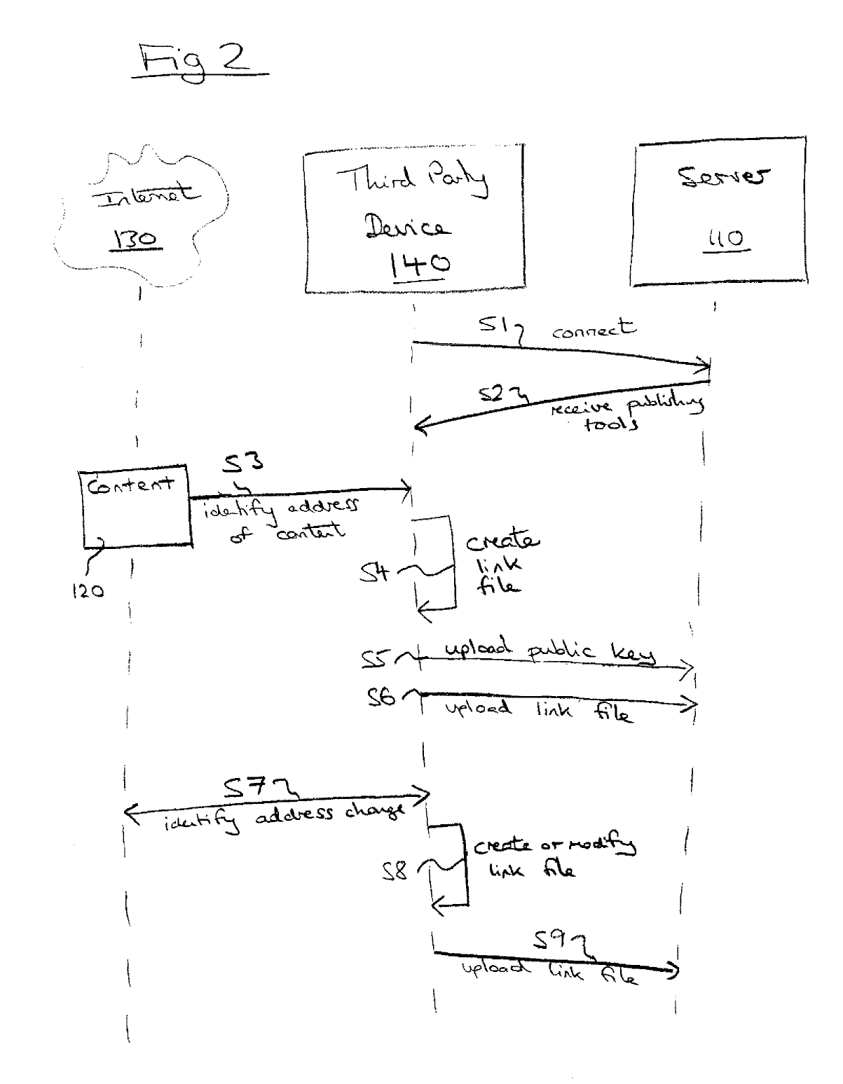

The method, according to one embodiment of the invention, by which the third party device provides link files to the server, will be described in more detail with reference to FIG. 2.

In a first step S1 the third party device 140 connects to the server 110. The server may verify that the third party device is eligible or registered. Verification methods are well know to the person skilled in the art and need not be discussed further. If the third party device fails this verification then the connection is closed and no further steps are performed.

In the second step S2 the server provides publishing tools to the third party device. These publishing tools may be provided to the third party device via a web interface, alternatively or additionally these publishing tools may comprise an application which is sent to the third party device and is executed thereon.

In some embodiments these steps may be carried out each time the third party device uploads or edits link files. Alternatively they may be performed only once.

In a third step S3, the third party device then identifies the address or addresses of content on the internet 130. While this step is described as subsequent to S1 and S2, it should be appreciated that this step is not dependent on the previous steps and may alternatively occur at any time before or during these previous steps. This step may be associated with further steps in which the third party device receives, modifies, creates and/or uploads the content onto the internet.

In a fourth step S4, the third party device creates one or more link files. These link files will contain one or more addresses. Additionally the link files may contain information related to these addresses, this information will be described in more detail later. In embodiments of the present invention the third party device encrypts the link files and/or addresses using a private key.

Encrypting prevents unauthorized changing of the link files and/or addresses. Associated with the private key is a public encryption certificate. This public encryption certificate enables user equipment to decrypt any encrypted link file and/or address. The public encryption certificate does not enable the link files or addresses to be changed. The public encryption certificates and/or the private keys may be provided by the server, or may be generated by the third party device or any other device.

In a fifth step S5, the third party device uploads any required public encryption certificates to the server. A public encryption certificate may be associated with each link file and/or address, alternatively or additionally a public encryption certificate may be associated with a third party device. It will be understood by the person skilled in the art that the public encryption certificate may only be uploaded once, providing it remains unchanged. The server may associate a public encryption certificate with link files and/or addresses which are subsequently uploaded.

In a sixth step S6, the third party device uploads the one or more link files to the server.

It should be appreciated that this steps S5 and S6 may be performed in a different order or at the same time.

In a particular embodiment, the server will therefore store: at least one link file containing at least one address, the link file and/or the at least one address being encrypted; and at least one public encryption certificate. There may be more than one third party device which connects to the server. Each third party device will be able to upload one or more link files.

In embodiments of the invention the third party device may choose to remove or modify addresses. This may happen if the content at the address is moved, deleted or becomes out of date. The following may therefore be performed.

In a seventh step S7, the third party device identifies that content identified by a particular address has been moved, deleted or is out of date. The third party device may also identify a new address if the content has been moved.

In an eighth step S8, the third party device creates or modifies one or more link files associated with this address. The link files thereby created may contain an indication that the address has been changed or deleted. Alternatively or additionally the modified link file may contain only current addresses, this modified link file replacing the previous link file.

In a ninth step S9 the third party device uploads the one or more new or modified link files onto the server. This step may be associated with a further step of uploading a public encryption certificate if it is required.

In the above method the third party device identifies the address of the content. In addition to this step the content may have been created and/or sent to the particular address.

The content may have been created locally by the third party device. Alternatively or additionally the content may have been created by a further device. This further device may have sent the content to the third party device.

The content may have been uploaded onto the internet by the third party device. Alternatively or additionally the content may have been provided on the internet by a further party.

In embodiments of the invention, the content may be stored on the third party device itself. Alternatively or additionally the content may be received and stored on the server in addition to the link file.

The above method might be used for the following:
a user publishing their own content links (to user generated content);
a company publishing links to their free content;
a company publishing links to protected (e.g. revenue generating) content that is still free to view;
a company publishing links to pre/post pay subscription services
a company publishing links to on demand services.

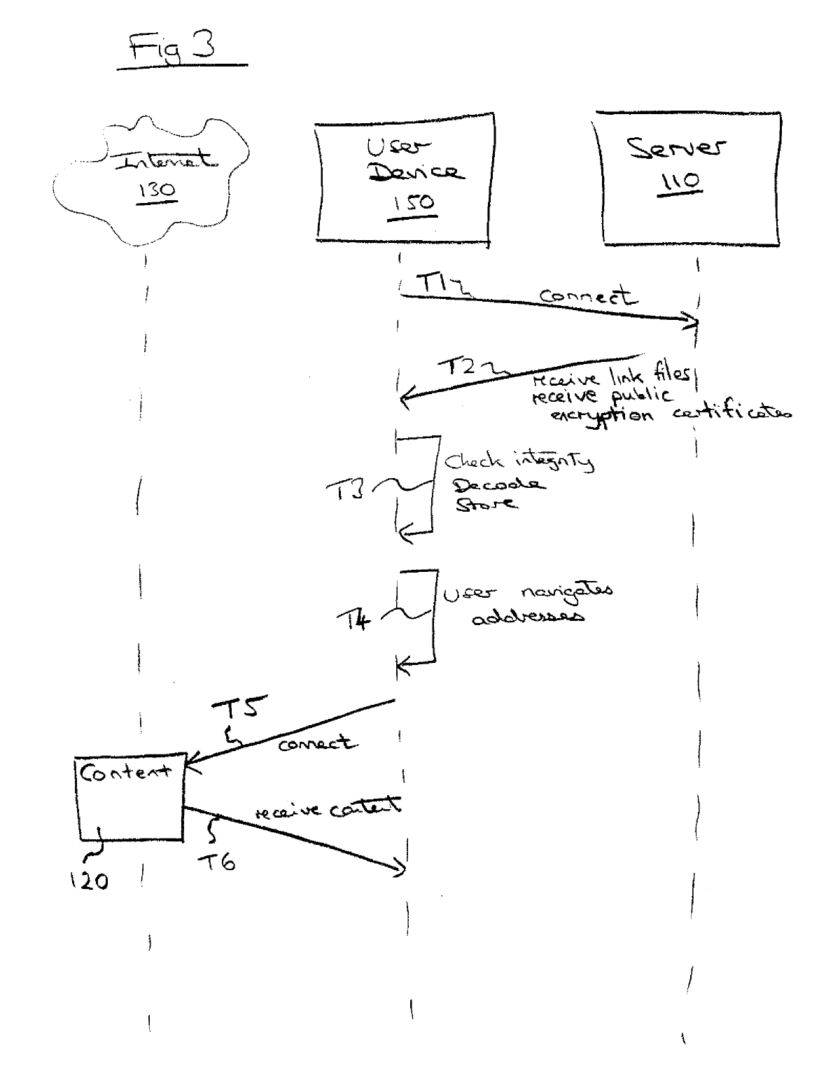

The method, according to one embodiment of the invention, by which user equipment receives link files from the server, will be described in more detail with reference to FIG. 3.

In a first step T1, the user equipment connects to the server. If this is the first time the user equipment is connecting to the server the user equipment may register with the server,

In a second step T2, the server provides the link files and public encryption certificates to the user equipment. In a preferred embodiment the server only provides those link files, parts of link files, and/or public encryption certificates which have been changed and/or added since the user equipment was last connected. This keeps data traffic to a minimum. The user equipment may provide an indication of which link files it has already received, alternatively or additionally a timestamp recording the last connection may be used to identify new and modified link files.

In a third step T3, the user equipment then checks the received files for integrity, decrypts the link files and/or addresses using the associated received public encryption certificate, and stores the addresses.

In a fourth step T4, the user of the user equipment navigates through the stored addresses. A suitable user interface on the user equipment may be used for this. This may include searching or browsing the addresses. The user may select an address.

In a fifth step T5, the user equipment connects to the content location as defined by the address and requests the specified content. In a preferred embodiment of the invention the user equipment connects to the content directly and not via the server.

In a sixth step T6, the content is provided to the user equipment.

In embodiments of the present invention the user equipment may connect to the server automatically or upon the request of the user of the user equipment. In alternative embodiments the server initiates a connection with the user equipment. This may occur, for example, when the server receives new or updated link files, or it may occur on a periodic basis.

This content to which the address link may be multimedia such as web pages, pictures, music, podcasts and video. The content may be downloadable or streamed. The content may be an interactive service. The content may be offered on the Internet or on any device to which the user equipment may connect. This content may be protected by various systems such as Conditional Access (CA) or Digital Rights Management (DRM) systems.

The link files may contain information describing the content provided at an address. This information may include but is not limited to: a title; description; the identity of the third party which uploaded the address; file category (such as audio, video, device UI skins or component updates); content category or genre (such as news or sport); file type (such as MP3 or JPEG); file size; whether the file is free to use or requires subscription or payment; location information; or user group information; links to payment system; type of content protection system; links to protection server; links to interaction servers; alternate sources of content. The use of location information and user group information will be described in more detail below.

The user equipment may define user preferences. Some or all of these preferences may be associated with the certain link file information as described above.

In embodiments of the invention the user equipment may automatically collect store or stream some or all of the content identified by the addresses. This may be performed based on: information associated with the address; user preferences; and/or one or more parameters of the device, for example storage capabilities. User confirmation may be required before this step is performed.

The user preferences may be used to manage, filter and/or categorize the addresses of content and/or content. The user preferences may be received and/or stored by the server. The server may perform at least some of this managing, filtering and/or categorizing based on these received and/or stored preferences. Alternatively or additionally the preferences are stored on the user equipment which performs at least some of this managing, filtering and/or categorizing based on these stored preferences.

In embodiments of the invention the user equipment is able to filter out addresses of information which it is unable to access.

In embodiments of the invention location information may be associated with the addresses. This location information may associate the content provided at the address with a given region or location. For example, if the content may be a local weather forecast or a regional news video. The user equipment may be able to determine its location, for example by using GPS or by other methods known in the art.

The above managing, filtering and/or categorizing of the addresses may be performed based on the location information associated with the address and/or with location information associated with the user equipment. The location information associated with the user equipment may be the user equipment's location or a user specified location. This location information may be stored in the user preferences.

User groups may be defined in the system. These groups may require invitation, subscription or registration. Users and/or user equipment may be associated with one or more groups. Addresses may be associated with one or more groups. Particular addresses may be restricted to those users and/or user equipment which are associated with a particular group. Alternatively or additionally the addresses may be managed, filtered and/or categorized based on the associated user group and/or user preferences.

A login name and/or password may be required to register a user and/or user equipment with a particular group. This may be stored in the user preferences. The server will receive this login name and/or password and will enable or restrict particular addresses accordingly.

Embodiments or the invention may allow a third party to provide content viewing authorization data to user equipment by means of the link files. This may be part of an address and/or part of information associated with said address. Alternatively or additionally this content viewing authorization data may be stored at the location indicated by said address. The third party may restrict access to this content viewing authorization data by, for example, requiring a login name and/or password to be provided by the user equipment in a similar manner to the login required by a user group.

In one embodiment of the invention the server itself is provided with a public encryption certificate, The server or an administrator thereof may define its own link files which are decrypted by means of this certificate. These files may contain revocation details. These link files may be sent to the user equipment. The user equipment may use the information in the link files to remove addresses from its database.

Such revocation link files may be created if the server provider, service provider or user community deem certain content to be unsuitable. The link files may specify the address of the content. Alternatively or additionally the link files may specify information associated with the address. The indicated addresses may be removed, or filtered in dependence on other conditions such as location.

Alternatively or additionally a particular third party may have its privileges revoked. One or more link files may be provided which indicate that all addresses provided by this particular third party are to be revoked. This may be done by specifying the addresses individually or by providing an indication of the third party. The indicated addresses may be removed.

The third party device may be a commercial computer system, a personal computer, a mobile phone, a digital camera, or any similar device.

The user equipment may be a mobile phone handset, mobile phone accessory, personal digital assistant (PDA), portable media player, digital camera, laptop computer, personal computer, set-top box, or television.

It will be understood by the person skilled in the art that a given device may perform the roles of both the third party device and the user equipment. Such a device will both upload and download devices link files. These devices may be collected in a sharing group.

The user equipment will be able to navigate the links stored on its database using methods known in the art. The information associated with an address may be used to aid this navigation, for example by grouping links by category.

Embodiments of the invention may provide a system for allowing an enabled multimedia device to manually or automatically discover, consume and publish back multimedia content/services and be capable of merging user generated content with protected content whilst preserving the content authors rights.

The same system may allow third parties (e.g. users or companies) access to a community of enabled multimedia devices to publish multimedia content/services for consumption and interaction with by users.

Embodiments of the invention may provide a simple yet powerful means of content/service discovery mechanism whilst the content/service is directly accessed from its owner.

Unlike the existing and inevitable disparate ‘look and feel’ of the current, different providers of search engines and service/content discovery mechanisms, embodiments of the invention may provide a consistent ‘look and feel’ in a single mechanism which can be accessed by all third parties.

Embodiments of the invention may comprise a system comprising a server and a community of enabled devices with the ability to discover/filter content from a number of delivery mediums. Content and service discovery/filtering is achieved by all enabled devices accessing a central server and thus receiving content link files that have been published by anyone wishing to allow the community of enabled devices to access their content from wherever it is located or stored. Thus the device user does not need to search for content as the links are effectively pushed to their device.

While this invention has been particularly shown and described with reference to preferred embodiments, it will be understood to those skilled in the art that various changes in form and detail may be made without departing from the scope of the invention as defined by the appendant claims.

1-43. (canceled)

44. A system comprising:
a server comprising means for storing at least one encrypted address of content provided by at least one third party, encryption information associated with said at least one encrypted address and description information associated with the content; and
means for filtering the description information on the basis of received user equipment preferences; the system further comprising at least one user equipment comprising:
means for receiving from the server one or more of said at least one encrypted address and said encryption information on the basis of the filtered description information;
means for decrypting at least one of said one or more received encrypted addresses using said encryption information; and
means for accessing a location of the content associated with one of said at least one decrypted address.

45. The system of claim 44 wherein said at least one user equipment comprises means for selecting one of said at least one decrypted address, said means for accessing a location associated with said selected address.

46. The system of claim 44 wherein the at least one third party provides one or more encrypted addresses to said server.

47. The system of claim 46 wherein the at least one third party comprises:
means for generating content;
means for providing said content to a content store,
wherein at least one of said one or more addresses is associated with the location of said content in said content store.

48. The system of claim 47 wherein the at least one third party or entity comprises said content store.

49. The system of claim 46 wherein one or more of the at least one third parties comprise user equipment and or a server.

50. The system of claim 46 wherein said description information comprises one or more of: a title; description; an identity of the third party associated with said address; file category; content category; genre; file type; file size; if the content is free to use; if the content requires subscription or payment; location information; user group information; links to a payment system; type of content protection system; links to a protection server; links to interaction servers; alternate sources of content.

51. The system of claim 46 wherein said at least one user equipment comprises means for filtering, managing and/or categorizing said at least one decrypted address in dependence on said description information.

52. The system of claim 46 wherein said user equipment defines said user equipment preferences, said user equipment preferences comprising at least one of:
a storage capability of the user equipment;
an ability of the user equipment to access the content associated with an address;
a user preference
a location of the user equipment;
a user specified location.

53. The system of claim 52 wherein said at least one user equipment comprises means for filtering, managing and/or categorizing said at least one decrypted address in accordance with said user equipment preferences.

54. The system of claim 46 wherein said at least one encrypted address is associated with information which is one or more of the following: interactive, user generated, free and/or rights managed.

55. The system of claim 46 wherein said encrypted address comprises associated content access authorization data generated by said at least one third party.

56. The system according to claim 46 wherein the user equipment is configured to filter out the address of the content if the user equipment is unable to access the content.

57. The system according to claim 46 wherein the third party publishes the encrypted address of the content, encryption information associated with said at least one encrypted address and description information associated with the content on the server.

58. The system according to claim 46 wherein the server pushes filtered encrypted addresses to the user equipment.

59. The system according to claim 46 wherein the at least one third party is a plurality of third parties and the at least one user equipment is a plurality of user equipments.

60. A server comprising:
means for storing at least one encrypted address of content provided by at least one third party and encryption information associated with said at least one encrypted address and description information associated with the content;
means for receiving user equipment preferences associated with at least one user equipment;
means for filtering the description information on the basis of the user preferences;
means for providing one or more of said at least one encrypted address and said encryption information to the at least one user equipment on the basis of the filtered description information.

61. User equipment comprising:
means for sending user equipment preferences associated with the user equipment to a server;
means for receiving from the server one or more encrypted addresses of content provided by at least one third party and encryption information associated with said one or more encrypted addresses, the at least one encrypted address being filtered based on the user equipment preferences and description information associated with the content;
means for decrypting at least one of said one or more received encrypted addresses using said encryption information; and
means for accessing a location of the content associated with one of said at least one decrypted address.
